(19) United States
(12) Patent Application Publication
(10) Pub. No.: US 2003/0037310 A1
(43) Pub. Date: Feb. 20, 2003

(54) Visual programming tool and execution environment for developing computer software applications

(76) Inventor: David Ge, Issaquah, WA (US)

Correspondence Address: DAVID GE, 10218 125TH AVE. NE, KIRKLAND, WA, 98033, US

(21) Appl. No.: 09/682,315

(22) Filed: Aug. 18, 2001

(51) Int. Cl. G06F 9/44

(52) U.S. Cl. 717/113

(57) ABSTRACT

A visual programming tool and execution environment, based on pre-developed object classes including an action class and an action list class, implemented on a computer having persistent storage, a display screen and one or more input devices which a user employs to command the said programming tool to develop software applications. The said pre-developed object classes which are used by the said programming tool support property-method-event model. In response to input from the user, the said programming tool creates object class instances from the said pre-developed object classes and graphically presents the said object class instances on the display screen; in response to input from the user, instances of object classes are manipulated graphically to form visual presentations of the software application; in response to input from the user, each property of each instance of object class is set; in response to input from the user, each event of each object class instance may be assigned an ordered action list as the event handler; each action in the said action list is formed by 1) an action performer which is an existing instance of object class; 2) an action method which is one of the single or plurality of methods of the said action performer; 3) action data if the action method requires it; in response to input from the user, each said action in the said action list is created by steps of 1) picking an instance of object class as the action performer from the existing instances of object classes presented to the user in an organized manner; 2) picking a method as the action method from the supported methods of the said picked instance of object class, the said methods are presented to the user on the display screen for the user to pick; 3) picking/specifying data for the said picked method via one or more dialog-boxes, if action data is required for the said picked action method. The said programming tool saves said object class instances and said action lists, together with the relationship between action lists and events of the said object class instances, to the computer persistent storage. What the said programming tool saves on the computer persistent storage form the software application developed by the user using the said programming tool. To execute the software application, the said programming tool reads back from the computer persistent storage the said saved object class instances, action lists and the relationship between action lists and events of the object class instances; creates and display the object class instances; responses to each event by sequentially executing each action in the said action list assigned to the said event; the said programming tool executes each action by the following steps 1) locating the object class instance which is assigned as the action performer for the action; 2) signaling to the said action performer which action method is specified for the action; 3) if the method data is specified for the said method of the said located object class instance, the method data is passed to the said object class instance as well; 4) the said located object class instance carries out the said action method.

### BACKGROUND OF INVENTION

This invention relates to a visual programming tool for developing software applications. A programming tool or a programming language has always to make a balance on easy-of-use and programming-limitations. Easy-of-use includes how wider range of people may comfortably use it, and how fast people may use it to develop software applications, Programming-limitations include the capabilities (what software can do) and efficiency (how fast software can run) of the software applications created by the programming tool or the programming language.

Ideally, we want a programming tool or a programming language to be the maximum easy-of-use with the minimum programming-limitations. In reality, when implementing one kind of programming tool or programming language, these two goals are often contradicting to each other and a programming tool or a programming language has to make trade-off between the two goals.

Machine languages is on one end of extreme representing the minimum programming limitations and hardest to use. Assembly languages make excellent trade-off on this balance, but it is still too hard to be used by most people. C language is much easier to use than Assembly languages with very little sacrifice on programming-limitations. That is why C language is much wider used than assembly languages. But still, lots of people cannot program in C language. Basic language reached relatively large number of people. Visual programming tools and integrated development environment (IDE) greatly enhanced the productivity of software development. But when we talk about the question of how wider range of people may comfortably use it, the deciding factor is the underlying programming languages, not much of the programming tools and IDE. If one cannot comfortably use the programming language, IDE cannot help. For example, being both visual programming tools, Visual Basic and Delphi are excellent IDE. But there are many more Visual Basic programmers than Delphi programmers, and one reason for it is that Basic language is much easier to command than Object Pascal which is used on Delphi.

One innovative idea Visual Basic brought and adopted by almost all later programming tools was that to use pre-built software components to develop new software applications. Programmers use programming languages to glue pre-built software components together to form new software applications. This way, programming skill requirements for a programmer is much lower than programming from scratch. This means that much wider range of people is able to do better programming jobs. Software application development can also be much faster.

When we examine programming languages, it is interesting to notice that structural languages like C, Pascal and Basic reached excellent balances on easy-of-use and programming-limitations. But these languages have all been moving to the so called “Object-Oriented” direction. For example, we have C++, Object Pascal and Visual Basic/Visual Basic.Net. New languages like Java and C# are, of cause, Object-Oriented. While Object-Oriented languages make it efficient in developing large projects, add great programming power to professional programmers, they achieve these power by sacrificing the easy-of-use. Thus fewer people are able to use these languages or use these Object-Oriented features.

Oppose to the trend of enhancing the power of programming languages, like Object-Oriented features, another trend is to reduce the importance of programming languages in programming tools, with the aim of totally eliminating the programming languages in the programming tools. This will greatly boost the easy-of-use of the programming tools. If we may totally eliminate programming languages in a programming tool, then hopefully any one who can use a word-processor can use such a programming tool.

One U.S. patent (U.S. Pat. No. 5,362,379) presents a visual programming tool which let users (programmers) visually link one C++ class to another thus forms program flow path, and use a script language to govern the execution behavior of those links. Using script languages is certainly much easier than using C/C++. U.S. Pat. No. 5,862,379 also uses many pre-created scripts to further reduce the need to create and edit scripts by the users. Nevertheless a fairly large part of U.S. Pat. No. 5,862,379 is to describe how the script language is used in that visual programming tool, although the script language it uses is a commercially available product. Similarly but without using script languages, a company called SoftWIRE Technology (www.softwiretechnology.com) created a product called SoftWIRE, which is used in Visual Basic environment; the pre-developed software components must have a special format to allow visually linking them together by a specially designed software component which the company calls it SoftWire. The company claims that “SoftWire to programming is what web browser was to the web”, because the company claims that “(using SoftWire) now everyone can create programs”. We may wait and see whether their claims will eventually become true, but “Everyone can create programs” is certainly the ultimate goal of the inventions in this field, including this invention.

All such inventions, including this invention, are trying to reach the goal of “Everyone can create programs” by creating a programming format or pattern; the format or pattern should make visual presentation and manipulation of each programming task possible; the programming-limitations are largely removed by the using of pre-developed software components. Different programming formats or patterns call for different user interfaces of the resulting programming tools. From a marketing point of view, the key is the user acceptance of the resulting user interface of the programming tools, and thus the underlying programming format or pattern. Some users may prefer one kind of user interfaces; other users may prefer the other kinds of user interfaces.

This invention uses a programming format which mimics a stage opera show. The using of the programming tool is like directing an opera by letting the right performers do the right things at the right time. Based on this idea, the visual programming tool created by this invention is much more intuitive and expected to have a much wider user acceptance.

U.S. Pat. No. 5,862,379 and SoftWire are similar in that both take the major programming task as to link the event firing object (source object) to the event consuming object (destination object). They adopt such a programming pattern so that it is possible to visually build program flow path. There should be people like this way of programming.

This invention uses a totally different approach and does not involve the concepts of “source object” and “destination object”. This invention puts an action performer concept in the center of a programming task; all software tasks to be programmed into an application belong to one or more action performers; any computer action must be carried out by an action performer; an action performer just carries out its own actions. This invention treats an event as a trigger to signal a set of action performers to start carrying out their own actions one by one. This reflects a fact that when a performer receives a signal to start performing an action, in some cases it does not matter much where the signal is come from. Using the programming tool this invention presents, when a user wants to make a software application to do some things, the user asks “who can do these things?” The answer is to find the right Action Performers provided by the programming tool to do the things. So the user selects and creates the action performers needed for her/his application. The user then asks “when each thing should be done?” The answer is to pick the right events. Programming process is thus simple and straight forward. Therefore this invention's approach will be much more intuitive to a wide range of non-technical oriented users.

This invention achieves code-less programming by building such a developing and executing environment such that all computer related capabilities are gathered into object methods, and a method is carried out only by the object that owns the method. Therefore, there is no need to use extra coding to invoke methods. The programming limitation will be the available object types for the users to use in their applications. More and more object types will be developed and available to the users to use, and thus keep maximizing the programming capability.

Although not in the same field as this invention presents, a different but a little similar idea was patented in the U.S. Pat. No. 5,522,073, which uses a “when/then” relation to control the execution of software tools and applications.

### SUMMARY OF INVENTION

In general, in one aspect the invention is a visual programming tool and method that includes an action object and an action list object, and a set of pre-developed objects which are derived from a generic object which supports a property-event-method model. The action list object contains a sorted list of action objects. An action object has, as its members, an action performer which is a derived non-abstract object of the said generic object; an action method which is one of the methods supported by the action performer; action data which are the parameters needed by the action method. The action list object is created and used by the user as event handlers.

The generic object is an object from which the other pre-developed objects are derived. Thus, it contains a set of properties and methods that are shared by the other pre-developed objects in the tool. The generic object makes a generic programming model and execution environment possible while more and more pre-developed objects may be added to the said programming tool in the future.

In general, in another aspect, the invention is a visual programming method that is implemented on a computer having a persistent storage, a display screen and one or more input devices which a user employs to command the said programming tool to develop software applications. The method includes: the steps of defining and supporting by computer implemented steps a set of pre-developed object classes, an action object class and an action list object class; in response to input from the user, creating object class instances from the said pre-developed object classes and graphically presenting the said object class instances on the display screen; in response to input from the user, instances of object classes being manipulated graphically to form visual presentations of the software application; in response to input from the user, each property of each instance of object class being set; in response to input from the user, selecting an event of an object class instance and assigning an action list object as the event handler; in response to input from the user, each said action object in the said action list object being created by steps of 1) picking an instance of object class as the action performer from the existing instances of object classes presented to the user in an organized manner; 2) picking a method as the action method from the supported methods of the said picked instance of object class, the said methods are presented to the user on the display screen for the user to pick; 3) picking/specifying data for the said picked method via one or more dialog-boxes, if action data is required for the said picked action method; indicating, in response from the user input, which object class instances are initially active objects; saving said object class instances and said action lists, together with the relationship between action lists and events of the said object class instances, and the indications of which objects are initially active, to the computer persistent storage.

In general, in another aspect, the invention is a software execution environment, which reads back from the computer persistent storage the said saved object class instances, action lists and the relationship between action lists and events of the object class instances, and the indication of which objects are initially active; creates and displays the object class instances which are initially active; responses to each event by sequentially executing each action in the said action list object assigned to the said event by the following steps 1) locating the object class instance which is assigned as the action performer for the action; 2) signaling to the said action performer which action method is specified for the action; 3) if the method data is specified for the said method of the said located object class instance, the method data is passed to the said object class instance as well; 4) the said located object class instance carries out the said action method.

The invention provides an intuitive graphical interface that enables non-technically oriented users to easily develop computer software applications, without any computer languages involved, not event script languages. It will open a new door of computer programming to a much wider range of people.

### BRIEF DESCRIPTION OF DRAWINGS

FIG. 1 is a block diagram of a typical system on which this invention is implemented as a software application program called the AP-Tool (Active Performer Tool);

FIG. 2 shows a typical computing environment which hosts the AP-Tool;

FIG. 3 shows a typical designer window that is displayed by the AP-Tool;

FIG. 4 shows a Designer Toolbox as displayed by the AP-Tool;

FIG. 5 shows a Property window as displayed by the AP-Tool;

FIG. 6 shows a Task Editor Window as displayed by the AP-Tool;

FIG. 7 shows the File menu as displayed by the AP-Tool;

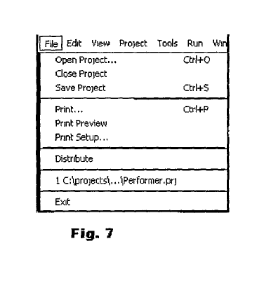

FIG. 8 shows the Edit menu as displayed by the AP-Tool;

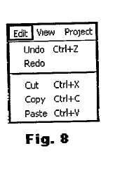

FIG. 9 shows the View menu as displayed by the AP-Tool;

FIG. 10 shows the Project menu as displayed by the AP-Tool;

FIG. 11 shows the Project Manager Window as displayed by the AP-Tool;

FIG. 12 shows a Project Editor dialog box as displayed by the AP-Tool;

FIG. 13 shows a typical AP Page opened in the Page Designer window as displayed by the AP-Tool;

FIG. 14 shows an Property Window which shows the event assignment as displayed by the AP-Tool;

FIG. 15 shows an AP Page opened in its Page Designer Window with the Property Window showing properties for an AP Object named ImageCompany as displayed by the AP-Tool;

FIG. 16 shows an Task Editor Window editing a task named “Company Info Slide Show (IBM)” as displayed by the AP-Tool;

FIG. 17 shows the Task Manager Window as displayed by the AP-Tool;

FIG. 18 shows a dialog box for the user to select action performer and action method as displayed by the AP-Tool;

FIG. 19 shows an action parameter dialog box as displayed by the AP-Tool;

FIG. 20 shows an action parameter dialog box as displayed by the AP-Tool;

FIG. 21 shows a file selection dialog box as displayed by the AP-Tool;

FIG. 22 shows an action parameter dialog box as displayed by the AP-Tool;

FIG. 23 shows an Task Editor Window editing a task named “Company Info Slide Show (MS)” as displayed by the AP-Tool;

FIG. 24 shows an action parameter dialog box for “switch event task” method as displayed by the AP-Tool;

FIG. 25 shows an AP Page opened in its Page Designer Window with the Property Window showing events for an AP Object named Button Slid ShowForward as displayed by the AP-Tool;

FIG. 26 shows a screen when a sample AP application is running;

FIG. 27 shows a screen when a sample AP application is running;

FIG. 28 shows a screen when a sample AP application is running;

FIG. 29 shows basic object structure of an AP application;

FIG. 30 shows the classes which are used to host AP-Tool in Microsoft Windows operating system via Microsoft Foundation Classes;

FIG. 31 shows the Run menu as displayed by the AP-Tool;

FIG. 32 shows the core object structure of the AP-Tool;

FIG. 33 shows the Tools menu as displayed by the AP-Tool.

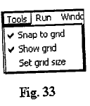

### Detailed Description

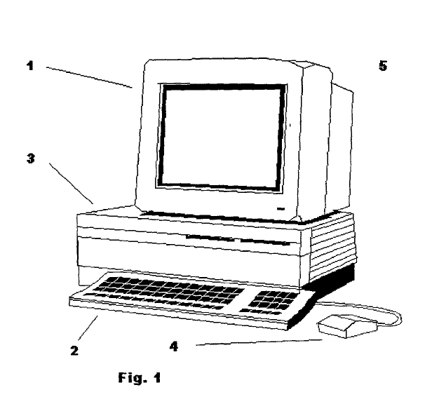

This invention is a visual programming tool (referred to hereinafter as AP-Tool, or Active Performer-Tool) that enables users to rapidly develop computer software applications (referred to hereinafter as AP applications). FIG. 1 shows a typical computer 5 the AP-Tool runs on. The computer 5 uses Microsoft.RTM.

Windows.TM. 98, Windows.TM NT4 or higher as its operating system. The computer includes a 64 MB random access memory and a 100 MB hard drive 3. Attached to the computer is a VGA or higher resolution monitor 1, a mouse 4 with right and left click buttons, and a keyboard 2. With AP-Tool running on the computer, the user can use the pointing device (e.g. the mouse) to simply draw objects on the computer screen, build action lists with the objects, and thereby build application programs which access, manipulate, process, and display data and other information.

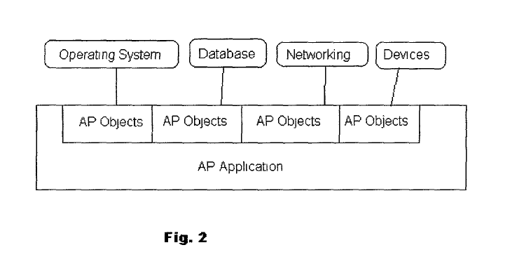

FIG. 2 shows a typical relationship between an AP application and its running environment.

The AP application which a user constructs using the visual programming tools of AP-Tool consists of a structured collection of objects called AP objects, a set of action lists, and a set of mapping relationships between events associated with each of these objects and the action lists. An action in an action list consists of an action performer object, an action method which is supported by the action performer, and a set of action parameters the action method requires. The user selects an AP object as the action performer from an organized object lists, which AP-Tool shows on the screen; the user selects a method from a method lists which AP-Tool presents on the screen based on the user choice of the action performer; the user chooses action parameters by dialog boxes which AP-Tool shows on the screen based on the user choice of action method. There is not computer programming language coding or script coding involved. When an AP application is running and an object event occurs, the AP application responds by locating the action list mapped to the event and informs the action performer objects in the list to carry out the action methods one by one.

### AP Objects

In an AP application, an object which is capable of carrying out some methods, firing some events, supporting some properties, is called an AP object. An AP application consists of one or more application windows, each of which is an AP object called AP Page object. Each AP Page object may contain a variety of other AP objects capable of carrying out a variety of methods, firing a variety of events, and supporting a variety of properties; such as showing pictures, playing videos, playing music, firing mouse events, keyboard events, timer events, supporting background color, windows sizes, etc.

### AP Object Classes

Each AP object is created from an AP object class. Each AP object class is defined by a set of methods, events and properties. More and more AP Object classes will be added to AP-Tool in the future.

### Properties of AP Objects

Properties define the behavior and/or appearance of AP objects. AP-Tool shows the object properties in a property window. The property window allows the user modify the property on the screen at the design time. The properties will be saved to persistent storage as part of the AP application. When an AP application starts, AP-Tool loads back the properties and re-construct the AP objects using the properties.

### Methods of AP Objects

Methods are tasks which AP objects are capable of doing when AP application is running. For example, AP Multimedia Object supports a method called “Play”. The object carries out this method by playing a video/music file given to it.

### Events of AP Objects

Events mark special times when an object's states change. Each AP object class may define a set of events. For example, AP Command Button Object supports mouse down event that marks the time when the user presses mouse key down on the button when an AP application is running.

### Action List

Action list is an ordered list of actions. It is built by the user when developing an AP application using AP-Tool. The user may build many action lists for many purposes. The user may assign an action list to events of AP objects. When an AP object fires an event, if there is an action list assigned to the event, the actions in the list will be performed one by one by the action performers.

### Action

An action consists of three elements: an action performer which is an AP object; an action method which the action performer supports; and action parameters which the action method requires. To perform an action, the action performer uses the action parameters to invoke its action method.

### Event-Action List Mapping

After creating AP objects and action lists, the user uses AP-Tool to build mapping relationships between object events and action lists. Building such relationships is a straight forward process using AP-Tool. The user picks an AP object from the screen, AP-Tool shows a list of events the object supports. The user picks an event from the screen, AP-Tool shows all the action lists the user built. The user picks an action list from the screen, and the mapping is set. AP-Tool saves these mappings to the persistent storage as part of AP application the user is developing.

### AP application files

An AP application is saved in a set of files using a Markup Language. Each AP Object is defined by a set of markup tags. Each AP Page Object with all the AP objects it contains is saved in one file. The AP Application Object is saved to another single file. Each action list is also saved in a separate file.

### The AP-Tool Development Environment

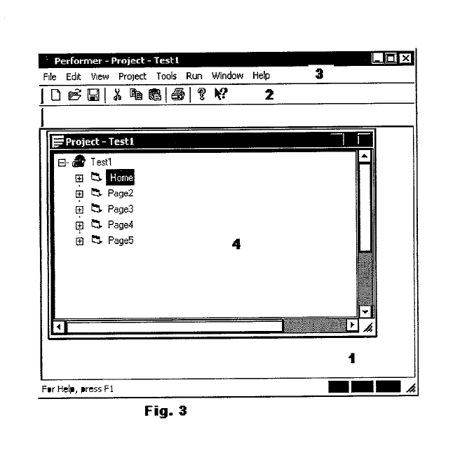

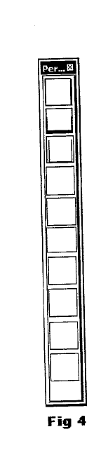

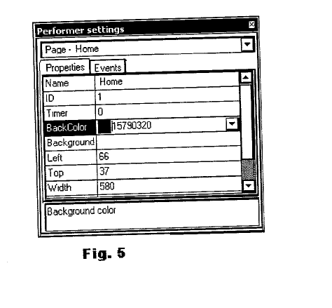

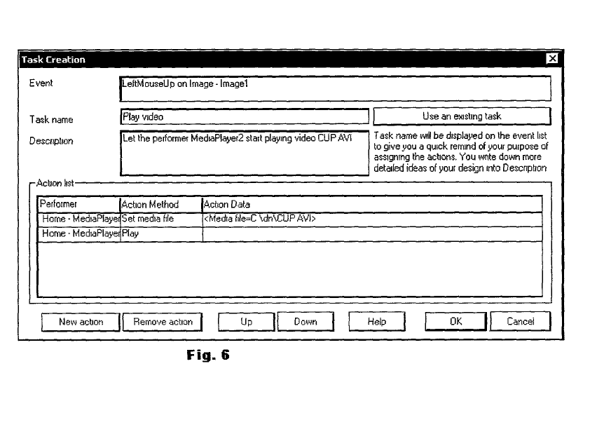

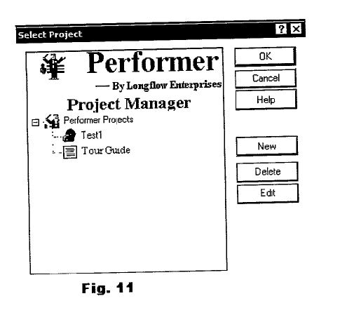

The AP-Tool development environment is a collection of tools for building AP applications. Referring to FIG. 3, these tools include an AP Desktop 1, a Toolbar 2, a menu bar 3, a Page-Manager window 4, a Toolbox (see FIG. 4), a Property Window (see FIG. 5), a Task-Builder (See FIG. 6), and Project-Manager (See FIG. 11).

### Project-Manager

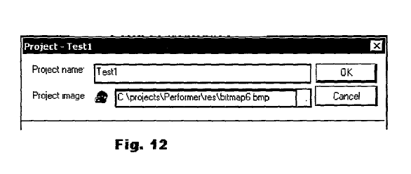

Referring to FIG. 11, Project-Manager lets users create, edit, delete projects. Each project represents one AP application. Each project is represented in Project-Manager window by a project name and an image. You may change project name and its image as shown by FIG. 12.

Select a project, then click the OK button, the project opens in the AP-Tool Development Environment, and displays the Page-Manager window (See FIG. 3).

### AP Page Designer

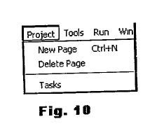

AP Page Designer is the tool the user uses to design graphic user interface of the AP applications. Double-click on the page name in the Page-Manager window 4 (See FIG. 3) to open the AP Page Designer. Use “New Page” menu item on Project menu to create new pages (See FIG. 10).

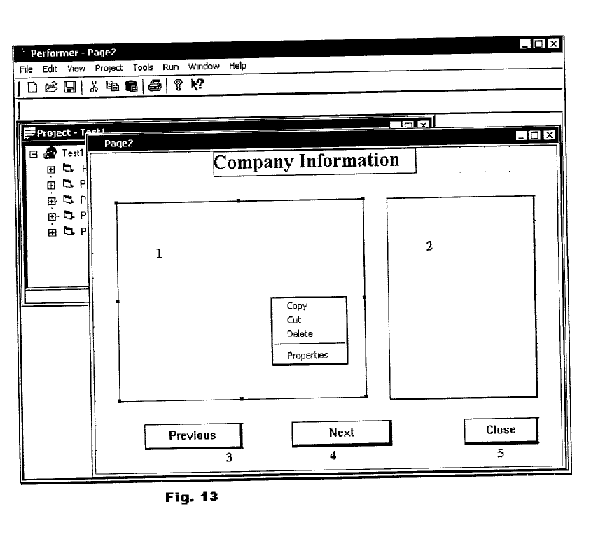

FIG. 13 shows the AP Page Designer for a page named “Page 2”.

### Designer Toolbox

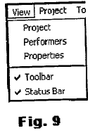

Designer Toolbox is a window (See FIG.4) where AP-Tool shows AP Object Classes which can be put on an AP Page. Choose menu item “Performers” under View menu to show the Designer Toolbox, see FIG. 9.

On the Designer Toolbox, each AP Object Class is represented by an icon. Drag an icon and drop it to an AP Page, an instance of that AP Object Class will be created on that AP Page on the location where the icon is dropped.

### Property Window

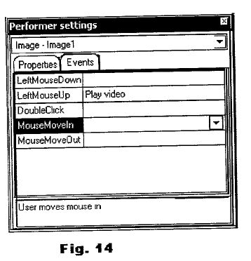

Property Windows is the working place where the user may change AP Object properties, assign action lists to events (See FIG. 5 and FIG. 14).

### Task Manager Window

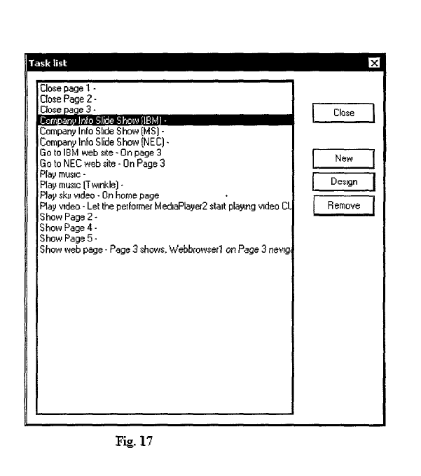

Tasks are created, edited, deleted in the Task Manager Window (See FIG. 17). Each task is represented by an action list.

### Task Editor Window

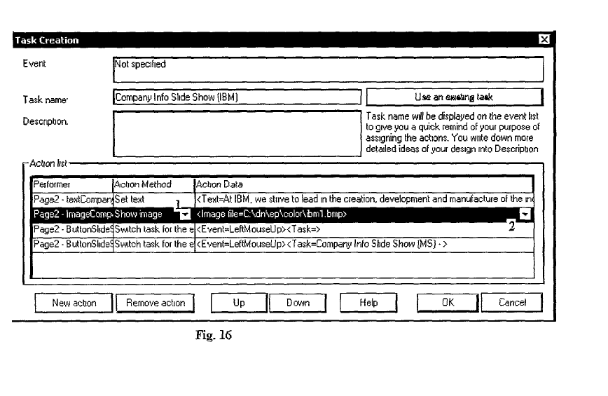

In the Task Editor Window, the user may create, edit, delete, re-order actions in the action list for the task (See FIG. 16).

### Descriptions of AP Object Classes

An AP application relies on AP Objects to fulfill any tasks the application is supposed to carry out. So the capability of an AP application is limited to the available AP object classes. When more and more AP object classes are put into AP-Tool development environment, the limitation to an AP application one can develop is less and less. AP object classes included in the current version of AP-Tool are described below.

### CPerformer Class

CPerformer is the top level class for all other AP object classes. It functions as an abstract class providing the most basic definitions and implementation of an AP object class. CPerformer itself is derived from CAPObject. CAPObject class provides the capability to serialize any of its subclasses by a markup language, and hence in a human readable format instead of binary format.

### CActivePerformerApp Class

CActivePerformerApp is derived from CPerformer. Every AP application has one and only one instance of this class. It represents an AP application. Currently it only supports one method: Exit. That is to shut down the AP application.

### CAPPage Class

CAPPage is derived from CPerformer. Each instance of CAPPage class is one page of the AP application, and may contain many other AP object classes derived from CAPComponent class, which is derived from CPerformer.

### CAPComponent Class

CAPComponent is derived from CPerformer. This is the top class for all the AP object classes that can be placed on an AP Page object which is an instance of CAPPage class.

### CMCIPlayer Class

CMCIPlayer class is derived from CAPComponent class. It can play multimedia contents like video and music.

### CAPCWeb Class

CAPCWeb class is derived from CAPComponent class. It is a web browser.

### CWndComponent Class

CWndComponent class is derived from CAPComponent class. Many AP classes with windowing support will be derived from this class.

### CAPCimage Class

CAPCimage class is derived from CWndComponent class. It can display various images including jpeg and Bitmap images.

### CAPCtext Class

CAPCtext class is derived from CWndComponent class. It can display text on the screen. It functions as a label control.

### CAPButton Class

CAPButton class is derived from CAPCtext class. It is a button on a page.

### CAPCEdit Class

CAPCEdit class is derived from CAPCtext class. It is a text box allowing user input.

### Designing a Page

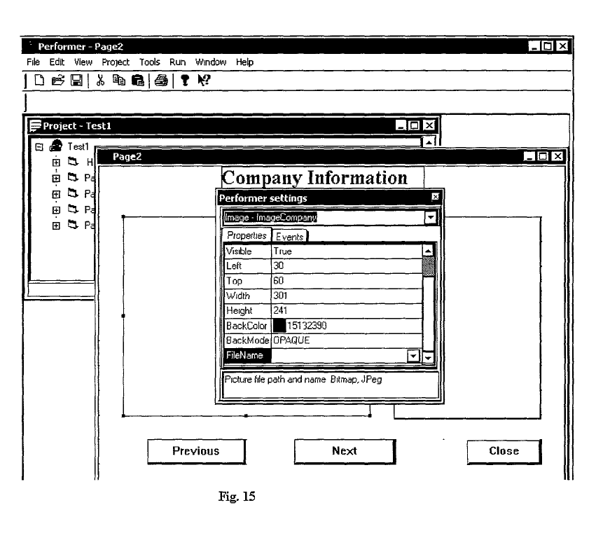

The user uses “New page” menu to create new pages (See FIG. 10). The user double-clicks on a page name in the Page-Manager window (See FIG. 3, item 4) to open a page in a page designer window (See FIG. 13). The user creates performer objects on the page by dragging a performer class from the toolbox window (See FIG. 4) and dropping it on the page. Initially the performer object will be created at the location where the user drops the performer class. Later, the user may drag the performer object around the page to re-position it anywhere on the page. The user may re-size the performer object by dragging one of 8 re-sizing boxes sit around its corners and sides (See FIG. 13). Right-clicking on the performer object brings up its context-menu (See FIG. 13). Referring to FIG.13, the performer 1's context-menu has 4 menu items: Copy, Paste, Delete, and Property. In FIG.13, the user created 6 performer objects on a page named Page 2. The performer object marked by number 1 is of a Picture class capable of showing images; the performer object marked by number 2 is of a Text class capable of showing text; the performer object displaying “Company Information” is serving as a page title and is also of a Text class; there are 3 other performer objects of Button class and shows captions “Previous”, “Next”, and “Close”. The user changes the performer objects' properties, for example, the caption on a Button, the text on a Text, the image file for a Picture, using the property window. Choosing the “Property” menu item from a performer's context-menu will bring up the property window showing the performer object's properties and events. FIG. 5 shows a property window for a page. FIG. 15 shows the property window for the Picture performer 1 on Page 2 (See FIG. 13).

### Programming in AP-Tool

Programming in AP-Tool is done by a code-less manner. The user first creates performer objects which are capable of doing the tasks of his/her application. The user then creates action lists to let the performers do their jobs. The user then assigns the action lists to the right events of the performers. An AP application is thus developed. When the AP application runs, at the right moment the right performers will start doing the right things.

Suppose Page 2 (See FIG. 13) is to be a slide-show screen showing company information for different companies. The company information consists of a picture and several paragraphs of texts. Flipping of slides is by clicking buttons.

### Step 1. Create Performers

To fulfill these tasks, referring to FIG. 13, a Picture performer 1 is created on Page 2 to show the company picture; a Text performer 2 to show company descriptions; a Button performer 4 to flip to the next company; a Button performer 3 to flip to the previous company; a Button performer 5 to close the page.

### Step 2. Create Tasks

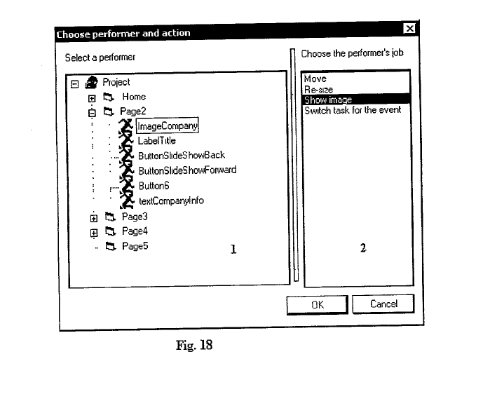

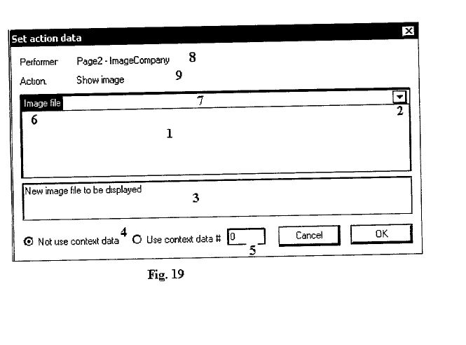

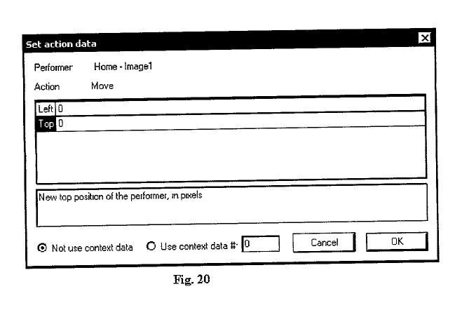

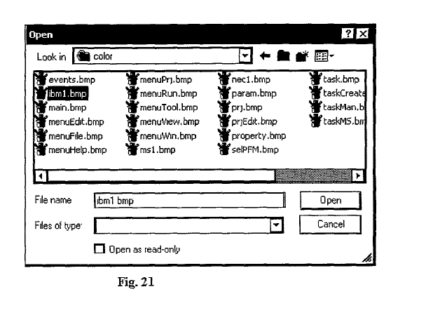

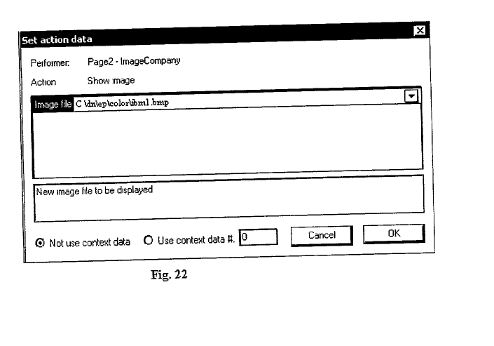

Now Page 2 has the performers capable of doing the tasks. Suppose that the first company to show is IBM. Menu item “Tasks” in Project menu (See FIG. 10) brings up a Task-Manager window (See FIG. 17). Referring to FIG. 17, a task called “Company Info Slide Show (IBM)” is created for the task of showing company information for IBM. On clicking on the “Design” button (See FIG. 17), the Task Editor Window shows up for this task (See FIG. 16). Apart from task name, the Task Editor Window also let the user give some descriptions to the task to help the user managing tasks. The major function of the Task Editor Window is to manage the actions in the action list for this task. Referring to FIG. 16, “New action” button let the user create a new action and add it into the action list, “Remove action” button let the user delete the selected action (shown highlighted on the screen) from the action list, “Up” button moves the selected action up in the action list so it will be performed earlier, “Down” button moves the selected action down in the action list so that it will be performed after the actions before it are performed. To select an action, click it using mouse or use up and down keys on the keyboard. To edit the selected action, use button 1 to select action performer and action method, use button 2 to select action parameters, see FIG. 16. Referring to FIG. 16, on clicking button 1, a performer selection window appears (See FIG. 18). Referring to FIG. 18, performer list 1 is organized by pages; method list 2 shows all the methods supported by the selected performer; selected performer is shown highlighted or outlined in the performer list. Referring to FIG. 16, on clicking button 2, an action parameter dialog box appears (See FIG. 19). FIG. 20 shows an action method which requires two parameters. Referring to FIG. 19, it shows action performer name 8, action method 9, and parameter list 1. Referring to FIG. 19, each parameter in the list has a name 6, parameter value 7, and a selection button 2. Referring to FIG. 19, each parameter has a description 3 which is only shown when the parameter is selected in the list. Referring to FIG. 19, to assign a parameter value, the user may type in the value edit box 7, or click the value selection button 2, or choose the “Use context data #:” option 4. The context-data is an array of values specific to the event when the action list s executed. For each event, the number and order of values in the context-data are pre-defined. For example, for a mouse-move event, the first context-data value indicates which mouse button is pressed, the second value indicates the X position of the mouse, the third value is the Y position of the mouse. Referring to FIG. 19, there is a text box 5 to let the user type in a number indicating which value in the context-data should be used for the value of the selected parameter. Number 1 indicates the first value, number 2 indicates the second value, and so on. Referring to FIG. 19, if value selection button 2 is clicked, depending on the type of the parameter, an appropriate dialog box will appear to let the user choose the value lie/she wants. For example, for a parameter of image file, a file selection dialog box will appear, see FIG. 21. On selecting the parameter value from a dialog box, the value will appear beside the parameter name, as shown in FIG. 22.

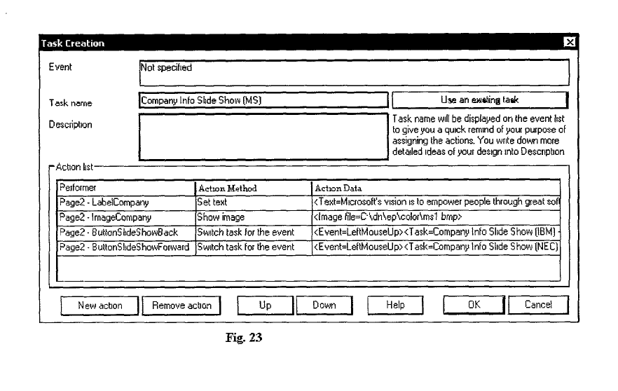

In the same way, we may create tasks to show other companies. FIG. 23 shows the task to show Company Information for Microsoft.

Referring to FIG. 16, the first two actions display image and descriptions for IBM. The next two actions re-program the buttons so that the “Previous” button will do nothing since IBM is the first company in the slide show, the “Next” button will carry out the task of “Company Info Slide Show (MS)” which is the task to show company information for Microsoft. Referring to FIG. 23, the first two actions of task “Company Info Slide Show (MS)” displays the image and description for Microsoft; the next two actions re-program the buttons so that the “Previous” button will carry out the task of “Company Info Slide Show (IBM)” and the “Next” button will carry out the task of “Company Info Slide Show (NEC)”. This shows the dynamic task assignment of AP-Tool.

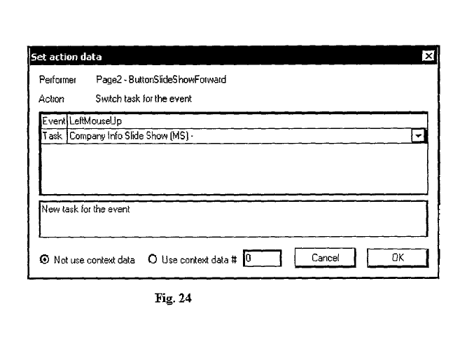

Every Performer Object supports a “Switch task for the event” method. This method has two parameters. The “Event” parameter indicates which event of the object will be assigned a new task; the “Task” parameter indicates which task is the new task to be assigned to this event. See FIG. 24.

### Step 3. Task Assignment to Events

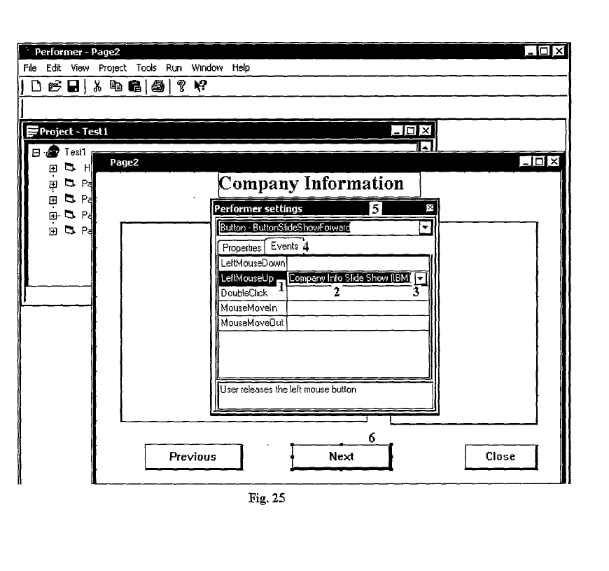

Many tasks are not assigned dynamically, but assigned at design time. Referring to FIG. 25, the Property Window 5 is shown for the “Next” button 6; selecting the “Events” tag 4 shows all the events of the button; selecting the event “LeftMouseUp” 1, which fires when the left mouse button is released; clicking selection button 3 and choose a task from the task manager window (See FIG. 17); the task selected shows as marked by number 2 in FIG. 25.

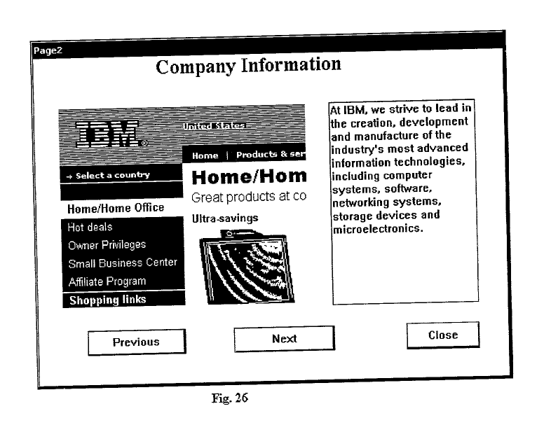

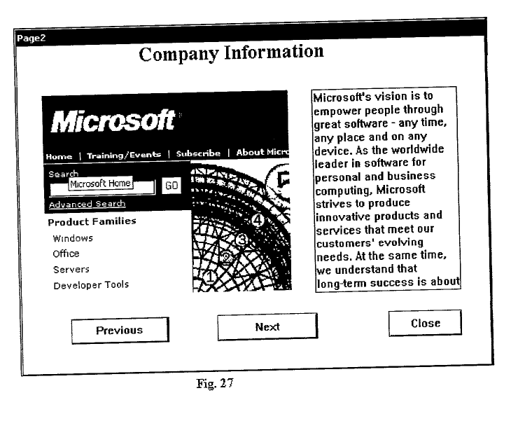

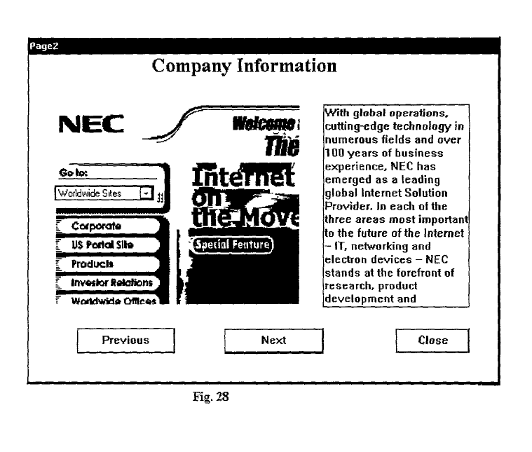

When this example AP application is running and Page 2 is showing, click the “Next” button, the information for IBM shows, see FIG. 26; click the “Next” button again, the information for Microsoft shows, see FIG. 27; click the “Next” button again, the information for NEC: shows, see FIG. 28.

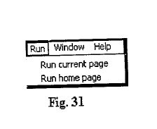

Menu “Run” provides two items: “Run current page” and “Run home page”. “Run current page” starts running from the page currently opened in the Page Designer Window. “Run home page” starts running from the home page. See FIG. 31.

### AP-Tool Application Structure

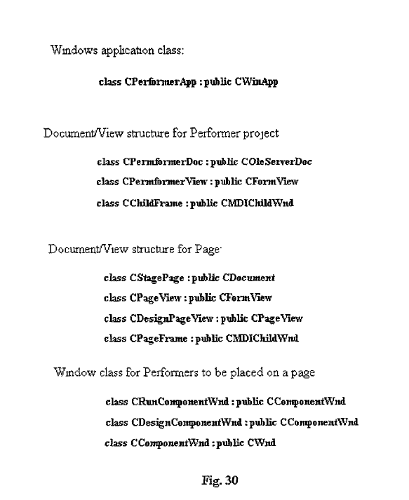

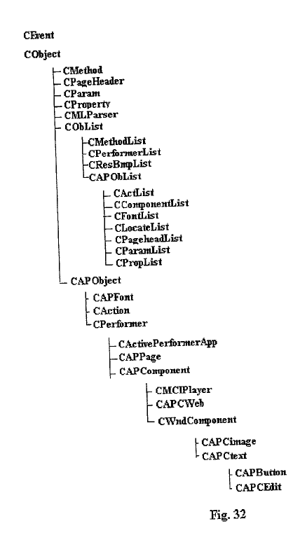

FIG. 32 shows the core classes of AP-Tool. It does not include Microsoft Windows application supporting classes, copy/paste classes, Undo/Redo classes and other supporting classes. FIG. 30 shows the classes to host AP-Tool into Microsoft Windows environment via Microsoft Foundation Classes (MFC). The Microsoft Windows application class of AP-Tool is CPerformerApp which is derived from MFC CWinApp class. Document/View structure of MFC is used to host AP-Tool to Microsoft Windows (See FIG. 30). Apart from using a few MFC, for example, CObject class for runtime type information support, the core AP-Tool structure and classes (see FIG. 32) does not use a lots of MFC and Microsoft Windows specific features; so the core structure can be hosted in other operating systems with a little porting efforts.

### AP Application Structure

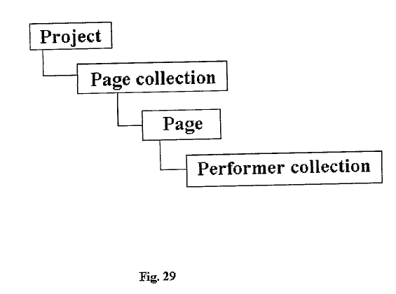

An AP application consists of AP pages and other performers. FIG. 29 shows the basic application structure of an AP application. An AP application consists of different kinds of AP Performer Objects all derived from CPerformer class. An AP application has one and only one CActivePerformerApp object which is derived from CPerformer class. A CActivePerformerApp class represents an AP application, also called a Project (See FIG. 29). An AP application also has many AP Page objects; each of which is an instance of AP Page class which is derived from CPerformer class. Referring to FIG. 29, each AP Page may contain many other AP Performers objects. There are many AP Performer classes; each is capable of doing certain methods. There will be more and more AP Performer classes developed in the future and available for an AP application to use. All kinds of AP Performer classes are derived directly or indirectly from CPerformer class.

An AP application has a page called Home Page, which is the starting point of the AP application. Initially an AP application displays the Home Page. The Home page, which itself is a kind of CPerformer object, and the CPerformer objects it contains will fire events; the tasks assigned to the events will start, and thus program keeps running.

### Major Classes

### CAPObject

This is the top-most class providing serializing functions enabling its derived classes to be able to serialize into a file in a markup language format. It works the same way as that Microsoft Foundation Classes makes C++ classes serializing to files in binary format. All AP-Tool classes are serialized in human readable markup language format instead of binary format.

### CMLParser

This is the class which a CAPObject class uses to do the markup language parsing.

### CPerformer

This is the top-most AP Object class. All other AP Object classes are derived from this class. It enables the property, method and event support for an AP object. Currently it has only one method: switch event task. So this is a method supported by all AP Objects. This method enables an AP object to dynamically change its tasks as its event handlers at runtime.

### CActivePerformerApp

This is an AP Object class. It represents an AP application; in AP-Tool environment, an AP application is also called a Project. Every AP application has one and only one CActivePerformerApp object. Currently it has only one method: exit. This method close the AP application represented this object.

### CAPPage

This is an AP Object class. It represents an AP page in an AP application. An AP page is a windowed displaying place on the screen. It may contain other AP objects in it. Currently it has the following properties, methods and events.

Page Properties:

Name of the page

ID of the page

Timer of the page

Page background color

Left position of the page

Top position of the page

Page width

Page height

Page icon

Page visible or hidden

Background image for the page

Page events:

Left mouse button released

Double-click

Mouse move into the page

Mouse move out of the page

Page methods:

Switch event task

Move the page on the screen

Change the size of the page

Show the page

Hide the page

Close the page

### CAPComponent

This is an AP Object. It is the top-most class for all the AP Object classes which can be placed on an AP Page. Currently it supports the following properties and methods:

CAPComponent Properties:

Performer name—The user uses it to identify the performer.

—ID Internal property used by AP-Tool to identify the performer.

VISIBLE—Indicate if the performer is visible on the page.

LEFT—Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

CAPComponent Methods:

Switch event task

### CMCIPlayer

It is an AP Object class. It can play multimedia contents like video and audio. Currently it supports the following properties, methods and events.

CMCIPlayer Properties:

Performer name —The user uses it to identify the performer.

ID—Internal property used by AP-Tool to identify the performer.

VISIBLE—Indicate if the performer is visible on the page.

LEFT—Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

FILENAME—Media file name to be played

SHOWBAR—Indicate if a media play control bar will be displayed or not

CMCIPlayer Methods:

Switch event task

Play the media file

Pause the play

Stop the play

Change the media file to be played

CMCIPlayer Events:

On play started

On play stopped

### CAPCWeb

This is an AP Object class. It is a web browser. Currently it supports the following properties, methods and events.

CAPCWeb Properties:

Performer name—The user uses it to identify the performer.

ID—Internal property used by AP-Tool to identify the performer.

VISIBLE—Indicate if the performer is visible on the page.

LEFT—Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

URL—Web address

SHOWADDR Indicate if the web address will be displayed

SHOWTOOL—Indicate if the toolbar will be displayed

SHOWSTATUS—Indicate if the status bar will be displayed

CAPCWeb Methods:

Switch event task

Go to the previous page in the web page history

Go to the next page in the web page history

Go to the specific web address

Show the web address

Hide the web address

Show the toolbar

Hide the toolbar

Show the status bar

Hide the status bar

### CWndComponent

This is an AP Object class. It provides some basic windowing supports so that other AP Object classes need windowing supports may be derived from this class. Currently it has the following properties, methods and events.

CWndComponent Properties:

Performer name—The user uses it to identify the performer.

ID—Internal property used by AP-Tool to identify the performer.

VISIBLE—Indicate if the performer is visible on the page.

LEFT—Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

CWndComponent Methods:

Switch event task

Move itself to a new position on the AP Page

Change the size of it

CWndComponent Events:

On left mouse button pressed

On left mouse button released

On double-clicking the mouse button

On mouse moving into it

On mouse moving out of it:

### CAPCimage

This is an AP Object class. It can display images. Currently it supports the following properties, methods and events.

CAPCimage Properties:

Performer name—The user uses it to identify the performer.

ID—Internal property used by AP-Tool to identify the performer.

VISIBLE—Indicate if the performer is visible on the page.

LEFT—Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

FILENAME—Image file path and name

CAPCimage Methods:

Switch event task

Move itself to a new position on the AP Page

Change the size of it

Show image

CAPCimage Events:

On left mouse button pressed

On left mouse button released

On double-clicking the mouse button

On mouse moving into it

On mouse moving out of it

CAPCtext

This is an AP Object class. It can display text on the AP Page. Currently it supports the following properties, methods and events.

CAPCtext Properties:

Performer name—The user uses it to identify the performer.

ID—Internal property used by AP-Tool to identify the performer.

VISIBLE—Indicate if the performer is visible on the page.

LEFT—Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

FONT—Font for the text

COLOR—Color for the text

TEXT—Text to show on the page

CAPCtext Methods:

Switch event task

Move itself to a new position on the AP Page

Change the size of it

Change the text to be displayed

CAPCtext Events:

On left mouse button pressed

On left mouse button released

On double-clicking the mouse button

On mouse moving into it

On mouse moving out of it

### CAPButton

This is an AP Object class. It is a command button on the page. Currently it supports the following properties, methods and events.

CAPButton Properties:

Performer name—The user uses it to identify the performer.

ID—Internal property used by AP-Tool to identify the performer.

VISIBLE—Indicate if the performer is visible on the page.

LEFT —Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

FONT—Font for the text

COLOR—Color for the text

TEXT—Text to show as the button caption

CAPButton Methods:

Switch event task

Move itself to a new position on the AP Page

Change the size of it

Change the text button caption

CAPButton Events:

On left mouse button pressed

On left mouse button released

On double-clicking the mouse button

On mouse moving into it

On mouse moving out of it

### CAPCEdit

This is an AP Object class. It shows a text editing box to let users type in it. Currently it supports the following properties, methods and events.

CAPCEdit Properties:

Performer name—The user uses it to identify the performer.

ID—Internal property used by AP-Tool to identify the performer.

VISIBLE—Indicate if the performer is visible on the page.

LEFT—Left position of performer on the page.

TOP—Top position of performer on the page.

WIDTH—Width of the performer.

HEIGHT—Height of the performer.

BKCOLOR—Background color of the performer.

BKMODE—Indicate if the performer's background appearance is transparent.

FONT—Font for the text

COLOR—Color for the text

TEXT—Text to show on the page

CAPCEdit Methods:

Switch event task

Move itself to a new position on the AP Page

Change the size of it

Change the text to be displayed

CAPCEdit Events:

On left mouse button pressed

On left mouse button released

On double-clicking the mouse button

On mouse moving into it

On mouse moving out of it

### CAction

This class represents an action. Its members identify the action performer which is an AP Object, the action method which is one of the supported methods of the action performer, and the action parameters which the action method requires. It is derived from CAPObject so that it will be serialized in markup language format.

### CActList

This class represents an action list. The action list is a linked list; each item of the list is a CAction object.

### Markup Language

A markup language is developed in making this invention. A parser is developed to use the markup language. The markup language is used to save and read back C++ classes. It uses tags to markup values. Anything outside of markups is ignored by the parser. A markup begins with <Tag> and ends with </Tag>.

The language is defined below:

1. Each member of a C++ class is given a Tag, which is part of the class definition

2. Each member value is saved between beginning markup <Tag> and ending markup </Tag> where Tag is its tag; <Tag> and </Tag> are this member's markups

3. If a member of the C++ class is not a C++ object, its value is placed between its markups in a string format

4. If a member of the C++ class is a C++ object, between its markups is that C++ object's markups and values and possible further nested markups and values

5. One single tag is given to any possible subclasses of the C++ class

6. The C++ class only defines tags for its members, but not for its subclasses members, and not for its super-classes members

7. Tag definitions are local to the C++ class itself, and are out of scope in its subclasses and its super-classes, and are out of scope in other classes. Any classes, subclasses, super-classes may freely define its tags without worrying about tag name conflicts. Within the class itself, not including its subclasses and super-classes, the tags must be unique.

Using the markup language parser to do C++ classes serializing is very similar in syntax to using the serialization functions in Microsoft Foundation Classes. The results are different though. The markup language parser produces human readable text files; Microsoft Foundation Classes produce binary files unreadable by human.

A sample markup language file recording an AP project:

<G> <L> <P> <N=Home> <I=1> </P> <P> <N=Page2> <I=2> </P> <P> <N=Page3> <I=3> </P> <P> <N=Page4> <I=4> </P> <P> <N=Page5> <I=5> </P> </L> <P> </P> <Z=> <F> <F> <D=1> <N=> <H=−16> <W=0> <E=0> <O=0> <T=700> <I=0> <U=0> <S=0> <C=0> <P=3> <L=2> <Q=1> <F=18> <M=Times New Roman> </F> <F> <D=2> <N=> <H=−24> <W=0> <E=0> <O=0> <T=700> <I=0> <U=0> <S=0> <C=0> <P=3> <L=2> <Q=32 1> <F=18> <M=Times New Roman> </F> <F> <D=3> <N=> <H=−21> <W=0> <E=0> <O=0> <T=700> <I=0> <U=0> <S=0> <C=0> <P=3> <L=2> <Q=1> <F=18> <M=Times New Roman> </F> <F> <D=4> <N=> <H=−35> <W=0> <E=0> <O=0> <T=700> <I=0> <U=0> <S=0> <C=0> <P=3> <L=2> <Q=1> <F=18> <M=Times New Roman> </F> <F> <D=5> <N=> <H=−37> <W=0> <E=0> <O=0> <T=700> <I=0> <U=0> <S=0> <C=0> <P=3> <L=2> <Q=1> <F=18> <M=Times NewRoman> </F> <F> <D=6> <N=> <H=−29> <W=0> <E=0> <O=0> <T=700> <I=0> <U=0> <S=0> <C=0> <P=3> <L=2> <Q=1> <F=18> <M=Times New Roman> </F> </F> <H> <H> <N=Play video> <I=1> <T> Let the performer MediaPlayer2 start playing video CUP.AVI</T> </H> <H> <N=Show Page 2> <I=2> <T> </T> </H> <H> <N=Show web page> <I=3> <T> Page 3 shows, Webbrowser1 on Page 3 navigates to www.microsoft.com</T> </H> <H> <N=Show Page 4> <I=4> <T> </T> </H> <H> <N=Show Page 5> <I=5> <T> </T> </H> <H> <N=Go to IBM web site> <I=6> <T> On page 3</T> </H> <H> <N=Go to NEC web site> <I=7> <T> On Page 3</T> </H> <H> <N=Close Page 2> <I=8> <T> </T> </H> <H> <N=Close page 3> <I=9> <T> </T> </H> <H> <N=Close page 1> <I=10> <T> </T> </H> <H> <N=Play skii video> <I=11> <T> On home page</T> </H> <H> <N=Play music> <I=12> <T> </T> </H> <H> <N=Play music (Twinkle)> <I=13> <T> </T> </H> <H> <N=Company Info Slide Show (IBM)> <I=14> <T> </T> </H> <H> <N=Company Info Slide Show (MS)> <I=15> <T> </T> </H> <H> <N=Company Info Slide Show (NEC)> <I=16> <T> </T> </H> </H> </G>

A sample markup language file recording a page:

<P> <N=Page2> <I=2> <T=0> <B=15790320> <R=86,37,580,420> <A> <CO> <N=ImageCompany> <I=1> <V=1> <B=15132390> <M=2> <E=0,0,0,0,0> <R=30,60,301,241> <D> <F=> </D> </C> <C1> <N=LabelTitle> <I=3> <V=1> <B=15132390> <M=1> <E=0,0,0,0,0> <R=150,0,246,30> <D> <N=2> <F=16711680> <T> Company Information</T> </D> </C> <C5> <N=ButtonSlideShowBack> <I=4> <V=1> <B=15132390> <M=2> <E=0,14,0,0,0> <R=60,330,119,30> <D> <N=0> <F=0> <T> Previous</T> <S> </S> </D> </C> <C5> <N=ButtonSlideShowForward> <I=5> <V=1> <B=15132390> <M=2> <E=0,14,0,0,0> <R=240,330,121,30> <D> <N=0> <F=0> <T> Next</T> <S> </S> </D> </C> <C5> <N=Button6> <I=6> <V=1> <B=15132390> <M=2> <E=0,8,0,0,0> <R=450,330,89,30> <D> <N=0> <F=0> <T> Close</T> <S> </S> </D> </C> <C4> <N=textCompanyinfo> <I=7> <V=1> <B=15132390> <M=2> <E=0,0,0,0,0> <R=360,60,179,245> <D> <N=0> <F=0> <T> </T> <E=0> </D> </C> </A> <F=> <S=0,0,0,0> <V=0> <K=> <E=0,0,0,0,0> </P>

A sample markup language file recording an action list:

<H> <A> <P=2> <C=7> <A=3> <L> <P> <T=9> <S=0> <D> At IBM, we strive to lead in the creation, development and manufacture of the industry's most advanced information technologies, including computer systems, software, networking systems, storage devices and microelectronics.</D> </P> </L> </A> <A> <P=2> <C=1> <A=3> <L> <P> <T=7> <S=180> <D> C:\dn\ep\color\ibm1.bmp</D> </P> </L> </A> <A> <P=2> <C=4> <A=0> <L> <P> <T=10> <S=0> <D> 1</D> </P> <P> <T=11> <S=0> <D> 0</D> </P> </L> </A> <A> <P=2> <C=5> <A=0> <L> <P> <T=10> <S=0> <D> 1</D> </P> <P> <T=11> <S=0> <D> 15</D> </P> </L> </A> </H>

1. A method for creating an application program, the method implemented on a computer system having persistent storage, a display screen and one or more input devices, the input devices controllable by a user to create visual representations on the dcisplay screen, the method comprising
A. defining and supporting a set of pre-developed object classes, the said pre-developed object classes are all derived from one generic class which supports a property-method-event model; defining an action class and an action list class; the action class has, as its members, action performer, action method, and action data; the action list class contains a sorted list of action class instances; the action performer is one of the pre-developed object class; the action method is one of the methods supported by the action performer; the action data are the parameters needed by the action method;
B. generating and graphically displaying, in response to input from the user, instances of the object classes from the said pre-developed object classes;
C. setting, in response to input from the user, each property of each instance of the object classes created in step B;

2. The method of claim 1 further comprising the step of:
D. creating, in response to input from the user, instances of the action list class which contains a sorted list of instances of the action class; Wherein step D comprises
D1. Creating, in response to input from the user, each action class instance of each action list class instance; and Wherein step D1 comprises:
D1a. Selecting an instance of object class from the instances of object classes created in step B; the said selected instance of object class is used as the action performer member for the action class instance;
D1b. selecting a method from the methods supported by the instance of object class selected in step D1a; the selected method is used as the action method for the action class instance;
D1c. according to the method selected in step D1b, it is known the number and types of the parameters needed for the said method; if one or more parameters are needed for the said method, then one or more dialog-boxes are provided for the user to specify the appropriate parameters for the method;

3. The method of claim 1 further comprising the step of
E. linking, in response to input from the user, action list instances created in step D to events of the instances of the object classes to form an event-action-list mapping; Wherein step E comprises:
E1. Selecting, in response to input from the user, an instance of object class from the existing instances of object classes;
E2. Selecting, in response to input from the user, an event from the events supported by the object class instance selected in step E1;
E3. Selecting, in response to input from the user, an action list class instance from the action list class instances created in step 2;
E4. Building the mapping relationship between the action-list selected in step E3 and the event selected in step E2;

4. The method of claim 1 further comprising the step of:
F. Selecting, in response to input from the user, a set of object class instances to be specified as the “initially active object class instances” usually the object class instances presented on the first application screen presentation is such a set of the “initially active object class instances”

5. The method of claim 1 further comprising the step
G. saving to the computer persistent storage the object class instances created in steps A, B and C, the action list class instances created in step D, the mapping relationship built in step E between the events of object class instances and the action lists, indication of which object instances are the “initially active object class instances” as specified in step F;

6. The method of claim 1 further comprising the step of:
H. an execution environment;
Wherein step H comprises:
H1. Reading back from the computer persistent storage the object class instances created in steps A, B and C, the action lists created in step D, the mapping relationship built in step E between the events of the object class instances and the action list, indication of which object instances are the “initially active object class instances” as specified in step F;
H2. Creating and displaying the said “initially active object class instances”
H3. Responding to each event fired by each object class instance;
Wherein step H3 comprises:
H3a. Checking if there is a mapping relationship between an action list class instance and the said event;
H3b. If the said mapping relationship exists, sequentially performing each action in the said action list mapped to the said event;
H3c. Each action in the said action list is performed by the following steps:
H3c1. Locating the object class instance which is assigned as the action performer for the action;
H3c2. Signaling to the said action performer which action method is specified for the action;
H3c3. If there are method data specified for the said method of the said located object class instance, the method data are passed to the said object class instance as well;
H3C4. The said located object class instance carries out the said action method.

7. The method of claim 1 further comprising the step of:
I. A context-data buffer which saves event parameter data such as mouse position in mouse movement events; every time an event is fired, before an action list is executed as an event handler, the said context-data buffer is filled with the said event parameter data;
J. The said context-data buffer is available for the user to pick as the method data in step D1c;

8. A method designed for object classes to dynamically change their event-action-list mapping at the runtime; any object classes may choose to support or not to support the said method; the said method has two parameters; the first parameter is the event identifier which identifies an event supported by the object class which is the owner of the said method; the second parameter is the action list class instance identifier which identifies an action list class instance;

9. The method of above claim further comprising the step of:
K. At the runtime, when an object class instance is asked to perform the said method, the said object class instance uses the first parameter of the said method to locate its event;
L. The said object class instance uses the second parameter of the said method to locate the action list;
M. The said object class instance rebuilds the event-action-list map using its event located in step K and the action list located in step L.
